(19) United States
(12) Patent Application Publication
(10) Pub. No.: US 2014/0072296 A1
(43) Pub. Date: Mar. 13, 2014

(54) METHOD AND A SYSTEM FOR PHYSICAL LAYER MONITORING IN PASSIVE OPTICAL NETWORKS

(71) Applicants: Julio Montalvo Garcia, Madrid (ES); Carlos Marin Arriaza, Madrid (ES)

(72) Inventors: Julio Montalvo Garcia, Madrid (ES); Carlos Marin Arriaza, Madrid (ES)

(73) Assignee: TELEFONICA, S.A., Madrid (ES)

(21) Appl. No.: 14/005,700

(22) PCT Filed: Mar. 8, 2012
(86) PCT No.: PCT/EP2012/054000

§ 371 Date: Nov. 18, 2013

(30) Foreign Application Priority Data
Mar. 18, 2011 (ES) 201130384

(51) Int. Cl. H04B 10/077

(52) U.S. Cl. CPC H04B 10/0775
USPC 398/16

(57) ABSTRACT

A method and a system for physical layer monitoring in Passive Optical Networks. The system comprises: —a light source (2) injecting a varying wavelength monitoring light signal at an input of a PON; —optical reflectors (8) provided at different points of said PON for receiving the monitoring light signal and reflecting back, each, that part of said monitoring light signal having a specific and individualized wavelength; —light detecting means (17) arranged for receiving said reflected light signals; and —analysis means connected to said light detecting means (17) and with access to previous knowledge about which specific wavelength each reflector (8) reflects, to determine the location of each of the optical reflectors (8) as a function of the arrival order, at said light detecting means (17), of its respective reflected signal. The method is adapted to use the system for physical layer monitoring in PONs.

### FIELD OF THE ART

The present invention generally relates, in a first aspect, to a method for physical layer monitoring in Passive Optical Networks (PONs), comprising emitting light to the interior of a PON and analysing the light reflected on respective optical reflectors provided at different points of the PON, and more particularly to a method which allows discerning to which reflector a corresponding reflected light signal belongs based on its wavelength.

A second aspect of the invention relates to a system arranged for implementing the method of the first aspect.

### PRIOR STATE OF THE ART

Currently, the deployment of Passive Optical Networks (PON) is taking place worldwide, being PON, GPON [1], EPON [2]) and Next Generation-PON (NGPON: 10G-GPON [3] and 10G-EPON [4]) systems considered as a future proof access network technology for supporting next generation broadband services.

The physical topology of PON systems is a point-to-multipoint (P2MP) tree-based architecture of single-mode fibre (SMF) starting with a feeder fibre from the Central Office (CO) where active equipment of the operator is installed. The feeder fibre is then delivered towards end users, being split in one or more steps by using optical power splitters in the outside fibre plant. As a consequence of optical power splitting, a large number of optical branches (from thousands to millions) appear in the outside plant.

This situation represents a challenging situation for operators providing access to PON users in terms of operational cost and service reliability, as the problems or defects that may appear in the physical layer of the PON topology must be rapidly detected and repaired.

The test methods for obtaining the main physical layer parameters (power attenuation, dispersion) in point-to-point (P2P) single-mode optical fibre links are well established [5], but are not useful for PON topologies. An efficient and cost-effective supervision of P2MP of passive optical networks is a new issue taking more importance as the worldwide PON deployment increases, because the number of optical branches in the outside plant pending from a single optical port in the CO can be very high (typically 64 or above) and so can be the power attenuation (typically above 20 dB for 1:64 splitting ratio of the PON). Recommendation ITU-T L66 [6] establishes the monitoring wavelengths for in-service access systems, but does not address the specific technological challenges and limitations in PON networks.

The P2MP topology of PON networks requires specifically designed physical layer test and monitoring systems for addressing the special needs of FTTx networks.

During the past decade, several techniques have been proposed and tested for monitoring the physical layer of PON systems. The most relevant of the proposed techniques rely of the capabilities of Optical Time Domain Reflectometry (OTDR) measurements from the CO and use optical reflectors in the outside fibre plant [7].

OTDR equipment is an optical test and measurement active equipment used for reflectometric characterization of optical fibre links. It launches optical pulses into an optical fibre and receives the distributed Rayleigh and Fresnel scattering reflections occurred during the propagation of the light pulses, thus characterizing the complete length of the fibre by correlating the reflections with reception time.

In the following section, the problems and technological limitations associated with OTDR measurements are explained in more detail.

Equipment providers of access systems are capable of remotely obtaining the optical power received by a single customer premises equipment (CPE), and these devices can send a signal to the Central Office at the time when they are powered off so that no alarm gets on when they are not detected in the network. Nevertheless, this supervision functionality is very limited, because in case that a CPE is alarmed, either a fault on its corresponding optical fibre or inside the device can be the cause of the alarm, and no physical layer information can be obtained.

OTDR measurements are a very effective solution for obtaining the physical characterization of an optical point-to-point (P2P) fibre cable, because the reflections obtained from the cable provide information about the localization and attenuation of connectors and splices, as well as the total attenuation.

Nevertheless, the P2MP topologies of PON networks is a very different environment for these measurements, because optical splitters in the outside plant cause a high attenuation of the monitoring signal launched from the OTDR equipment and, most importantly, the backscattered reflections from the different fibre branches overlap in time when they reach the Central Office, being very difficult or impossible to identify and discern the problems occurred in a single fibre branch.

In FIG. 1, an 8 branched PON built with a 1:8 power splitter (PS) is shown, with each fibre ended with connectors at different distances from the CO.

FIG. 2 shows the OTDR traces received at the CO as the reflections accumulate from fibre 8 (i=8) to fibre 1 (i=1) (7).

It can be seen how the splitting losses of the power split appears to be several dBs lower than the real losses, due to the powers accumulated from all the fibre branches.

The use of optical reflectors in the user-end of the fibre branches has also been proposed, being the reflections from each fibre end related to a specific distance and thus associated to an individual user [8]. Nevertheless, in massive PON deployments with high service penetration, and especially in high-density urban areas, the distances at which users may be connected to the PON can be very similar or identical, and so the identification of the fibre branch where a problem occurs can be difficult or not feasible. Moreover, due to the high power attenuation of the PON in the final sections of the PON, OTDR traces are very noisy and may not provide any information about the problem in the fibre plant.

Another remarkable approach that can partially avoid these limitations consists of using Brillouin-based OTDR measurements and deploying individually assigned Brillouin frequency shifted fibre branches in the last sections of the PON connected to the end-users [9]. Nevertheless, the maturity of Brillouin OTDR technology is very low and the equipment is not commercially available in the market. Another relevant drawback of this Brillouin shift approach is the need for employing different single mode fibres for each branch of the PON, which highly increases the cost and the complexity of the PON deployment.

US 2009/0269053 A1 [10] provides a method and apparatus for determining a failure of an Optical Network Unit (ONU) before a PON system failure occurs, by collecting and analyzing the monitoring information from both the Optical Line Terminal (OLT) and the ONU. Nevertheless, said proposal is not capable of obtaining physical-layer information of the PON.

U.S. Pat. No. 6,396,575 B1 [11] discloses a test and measurement system for detecting and monitoring faults and losses in passive optical networks, where polarization dependent components are installed before and after the drop fibres in the PON. OTDR pulses with controlled polarization states, associated with each polarization marker, are used as the basis for distinguishing the branches from one another. Apart from the need for polarization controllers and compensators, said proposal does not solve the problem of lack of signal quality of OTDR traces after a high splitting ratio in the PON.

### DESCRIPTION OF THE INVENTION

It is necessary to offer an alternative to the state of the art which covers the gaps found therein, particularly related to the lack of proposals which really allow discerning from the different reflections coming from different points of a PON in a cost-effective way and using mature technology.

To that end, the present invention provides, in a first aspect, a method for physical layer monitoring in Passive Optical Networks, comprising:

a) providing optical reflectors at different points of a Passive Optical Network, or PON;

b) injecting a monitoring light signal at an input of said PON to circulate there through;

c) reflecting back, said optical reflectors, at least part of said monitoring light signal, in the form of respective reflected light signals;

d) receiving said respective reflected light signals from said optical reflectors; and

e) analysing said received reflected light signals to perform a physical layer monitoring of the PON.

On contrary to the known proposals, in the method of the invention, in a characteristic manner:

said step a) comprises providing said optical reflectors for reflecting, each, a light signal with a specific and individualized wavelength;

said step b) comprises varying the wavelength of said monitoring light signal through a specific range covering the individualized wavelengths that said optical reflectors reflect; and

said step e) comprises determining at least the location of each of said optical reflectors as a function of the arrival order, at said PON input, of its respective reflected signal, using previous knowledge about which specific wavelength each reflector reflects.

For a preferred embodiment, the method comprises using a tunable laser source to emit said laser light signal in the form of a continuous-wave signal.

Other embodiments of the method of the first aspect of the invention are described according to appended claims 2 to 11, and in a subsequent section related to the detailed description of several embodiments.

A second aspect of the invention concerns to a system for physical layer monitoring in Passive Optical Networks, comprising:

a light source arranged for injecting a monitoring light signal at an input of a PON to circulate there through;

a plurality of optical reflectors provided at different points of said PON for receiving said monitoring light signal and reflecting back at least part thereof, in the form of respective reflected light signals;

light detecting means arranged for receiving said respective reflected light signals from said optical reflectors; and

analysis means connected to said light detecting means for analysing said received reflected light signals to perform a physical layer monitoring of the PON.

In the system of the second aspect of the invention, on contrary to the known systems mentioned in the prior state of the art section, and in a characteristic manner:

said optical reflectors reflect, each, a light signal with a specific and individualized wavelength;

said light source varies the wavelength of said monitoring light signal through a specific range covering the individualized wavelengths that said optical reflectors reflect;

said light detecting means detect light signals of at least said wavelengths specific range; and

said analysis means have access to previous knowledge about which specific wavelength each reflector reflects, and determine, using said previous knowledge, at least the location of each of said optical reflectors as a function of the arrival order, at said light detecting means, of its respective reflected signal.

According to a preferred embodiment of the system of the second aspect of the invention, said light source is a tunable laser source which emits said monitoring light signal in the form of a continuous-wave laser light signal.

The system of the second aspect of the invention is adapted to implement the method of the first aspect.

Other embodiments of the system of the second aspect of the invention are described according to appended claims 13 to 23, and in a subsequent section related to the detailed description of several embodiments.

### BRIEF DESCRIPTION OF THE DRAWINGS

The previous and other advantages and features will be more fully understood from the following detailed description of embodiments, with reference to the attached drawings (some of which have already been described in the Prior State of the Art section), which must be considered in an illustrative and non-limiting manner, in which:

FIG. 1 shows an 8 branched PON built with an 1:8 power splitter (PS).

FIG. 2 shows the OTDR traces received at the Central Office (CO) as the reflections accumulate from fibre 8 (i=8) to fibre 1 (i=1) (7).

FIG. 3 shows the Wavelength plan for PON systems.

FIG. 4 illustrates the architecture of the monitoring system of the second aspect of the invention for an embodiment where it is applied to only one PON.

FIG. 5 illustrates the Tunable Laser Source (TLS) wavelength detuning.

FIG. 6 shows the implementation of the monitoring system of the second aspect of the invention for an embodiment where it is applied to N different PONs using a 1×N optical switch 18 in the Central Office and sharing the CO equipment.

FIG. 7 discloses the temporal distribution of the monitoring light signal used for being sequentially applied N PONs, as per the embodiment of FIG. 6.

FIG. 8 shows the architecture of the monitoring system of the second aspect of the invention for an embodiment similar to the one of FIG. 4, but with a reduced filter installation

FIG. 9 shows the number of filters required for both installation options, the one of FIG. 4 and the one of FIG. 8, for different splitting values of the first-level and second level splitters and for a total splitting ratio of 1:32.

FIG. 10 shows the number of filters required for both installation options, the one of FIG. 4 and the one of FIG. 8, for different splitting values of the first-level and second level splitters and for a total splitting ratio of 1:64.

FIG. 11 shows a schematic of the reflected signals collected in the Monitoring System of the second aspect of the invention according to an embodiment.

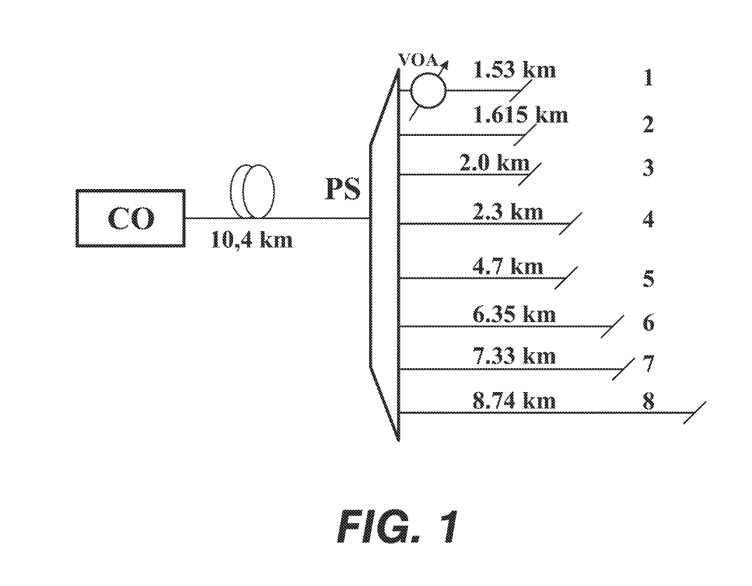

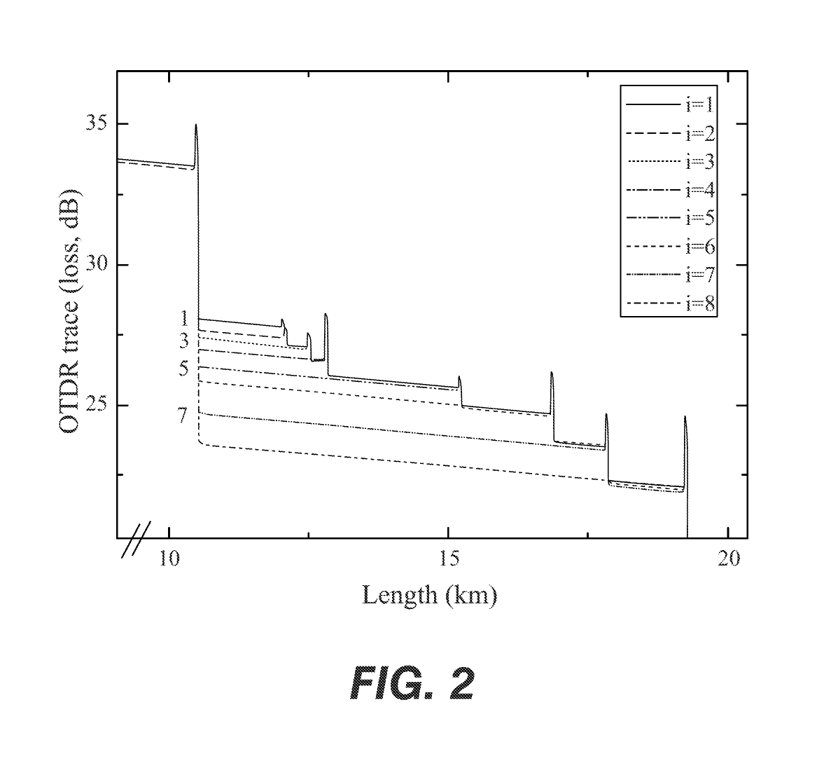

### DETAILED DESCRIPTION OF SEVERAL EMBODIMENTS

As stated above, the present invention refers to a centralized measurement system and method for remotely obtaining the optical power losses of the main optical passive components and fibre cables of a PON access network with data equipment in service.

This invention is relevant in the field of optical access networks with point-to-multipoint topology (G-PON [1], 10G-GPON [3], E-PON [2], 10G-EPON [4]). These PON systems are being deployed and considered for future deployment as future-proof optical access systems for providing next generation broadband services.

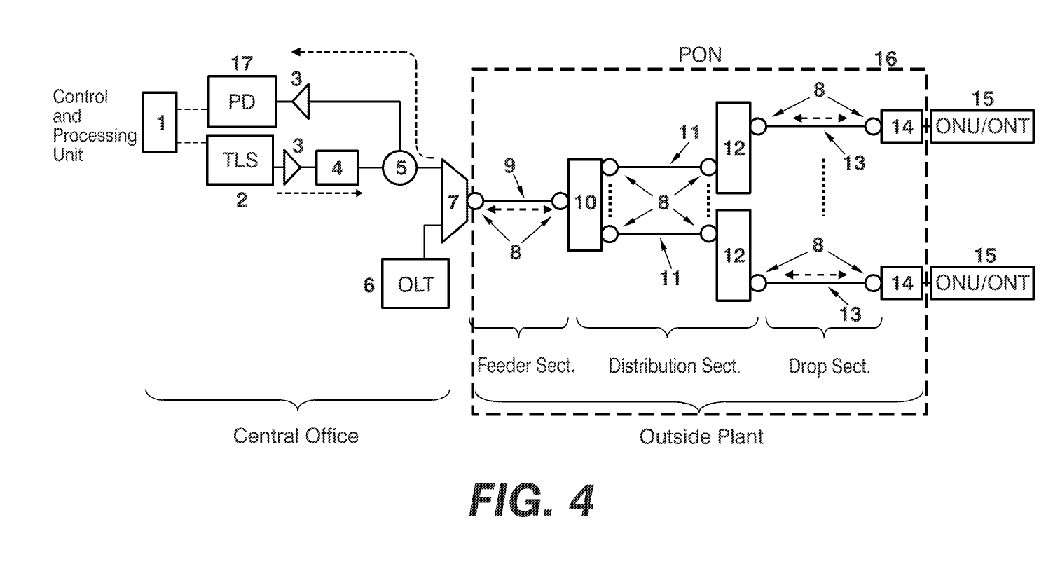

For the illustrated embodiments, the system consists of a Tunable Laser Source (TLS) delivering an optical continuous-wave signal to the outside fibre plant and a set of reflectors installed in the outside fibre plant (see FIG. 4). The wavelength of the optical source periodically spans the optical bands of the reflectors, while keeping the power of the laser constant. The laser power can also be turned down at specific intervals of the sweeping period if data transmission is performed between any of the monitoring optical bands of the reflectors, thus avoiding interference.

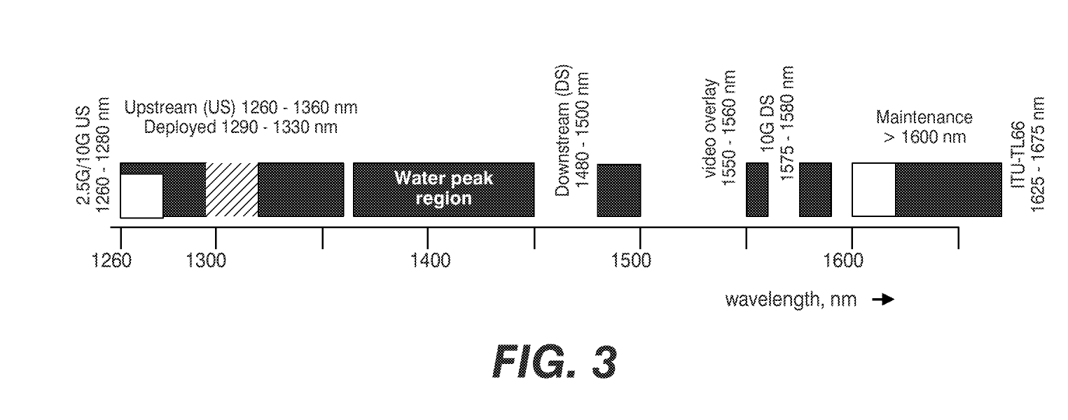

The monitoring wavelengths of the reflectors can be located at a single band or at multiple bands, as far as they do not interfere with data communication wavelengths (see FIG. 3). Water peak region and maintenance band are available for the purpose of this invention. As the video overlay (1550-1560 nm) is optional, in some cases its bandwidth is also available for PON monitoring.

The optical reflectors can be Fibre Bragg Gratings (FBGs) or reflective Thin Film Filters (TFF), which are two-ports passive components with specific and different central wavelengths within the monitoring band, and they can be directly installed in the PON outside plant as in-line elements. They are transparent to the protocols employed in the data signals.

Fibre Bragg Gratings are two-ports passive fibre optic filters fabricated by modulation of the refractive index of the optical fibre core along a certain length. By designing the period and longitudinal core index modulation profile, the reflected and pass band optical spectra of the incident light can be selected.

Thin Film Filters are optical filters fabricated by deposition of alternating layers of optical coatings with different refractive indexes upon a glass substrate. By controlling the thickness and number of the layers, the wavelength of the pass band of the filter can be tuned and made as wide or narrow as desired, while the rest of the light is reflected.

The reflections from the FBGs or TFFs are sequentially received from the outside plant as the TLS tunes in time to their corresponding central wavelengths.

The conceived system and method allows a simple analysis of the reflections by relating the sequential order of the power reflections and the database of the elements installed in the outside plant.

The current invention allows a complete characterization of in service PON networks in terms of power losses of the splitters and fibre cables from the Central Office to the end-user equipment.

It is a low cost and efficient solution that avoids the use of expensive equipment such as Optical Time Domain Reflectometers and Optical Spectrum Analyzers (OSA).

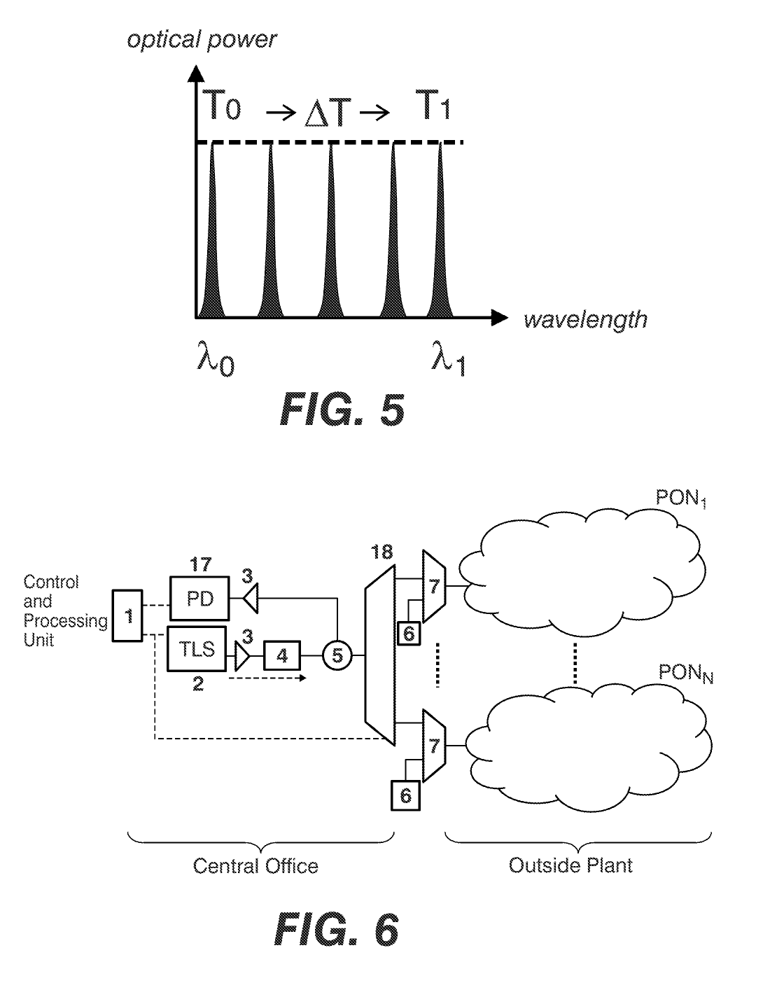

FIG. 4 shows the schematic architecture of a PON with the proposed monitoring system, and FIG. 5 shows the wavelength sweep of the TLS 2 from the starting value λ0 to the final value of λ1, being λ0<λ1. The wavelength range between λ0 and λ1 must be within an available band of the PON system. FIG. 6 shows the implementation of the monitoring system for N different PONs (PON₁ to PON_{N}) using a 1×N optical switch 18 in the Central Office and sharing the CO equipment.

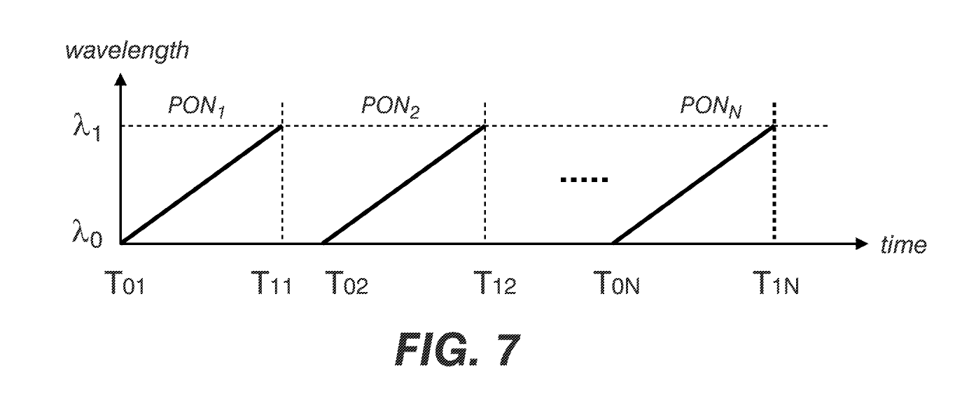

The Control and Processing Unit 1 commands the TLS 2 in order to make its wavelength periodically sweep in a time interval [T1i-T0i] for PONi (i=1 . . . N) from λ0 to λ1, as shown in FIG. 7.

The optical switch sequentially opens a transparent optical path from its input (connected to circulator 5) to its N outputs (connected to WDMs 7) each of these latter delivering the monitoring signal from the TLS to all the PONs. The switching time must be lower than the minimum value from T0i-T1i−1 (i=1 . . . N).

The continuous wave optical signal emitted the TLS is optionally amplified, depending on the monitoring system optical power budget, by an optical amplifier 3 and then sent to an optical filter 4 that blocks the optical bandwidth that may be reserved for the PON data channels or enhancement band. The output of the filter 4 is delivered to the PON via an optical circulator 5 the 1×N optical switch 18 and a bidirectional WDM multiplexer-demultiplexer 7.

The considered PON is typically built with a feeder fibre 9 (see FIG. 4) connecting the OLT 6 to the first-level power splitter 10 (splitting ratio equals 1:m), a distribution section with the fibres 11 connecting the first-level splitter 10 to the second-level splitter 12 (splitting ratio equals 1:n), and a drop section comprising the drop fibres 13 attached to the end-user equipment (ONU/ONT) 15.

By means of the method and system of the invention, an inventive use is provided of Tunable Laser Source (TLS) 2, Broadband Photo-Detectors (PD) 17 and FBGs or TFFs 8 for analysing peaks of reflected optical power which are consecutive in time and calculating their power ratios in order to calculate the optical losses of the main components and sections of the PON network.

The broadband optical-to-electrical detector used does not require to have optical tunable elements in the Central Office.

Moreover, an inventive use of Fibre Bragg Gratings (FBGs) or Thin Film Filters (TFFs) 8 with athermal packaging and different central wavelengths for obtaining power attenuation in the splitters 10, 12 and fibre cables 9,11,13 that form the outside fibre plant of a PON network, is also provided, for some embodiments.

In order not to induce interference with the data signals in the end-user equipment (ONT/ONU), an optical filter 14 must be employed before or inside the ONT/ONU, blocking the monitoring signal within the λ0-λ1 optical band and letting the downstream and upstream signals propagate between OLT and the ONT/ONU.

In-line TFF or FBG filters 8 with different central wavelengths are installed both at the input and the output of the optical fibres in the feeder, distribution and drop sections of the PON. The input of each fibre cable refers to the end closer to the CO, while its output refers to the end closer to the ONT/ONU. For a high number of monitoring points, optical reflectors with 50 GHz or lower central wavelength separation are commercially available.

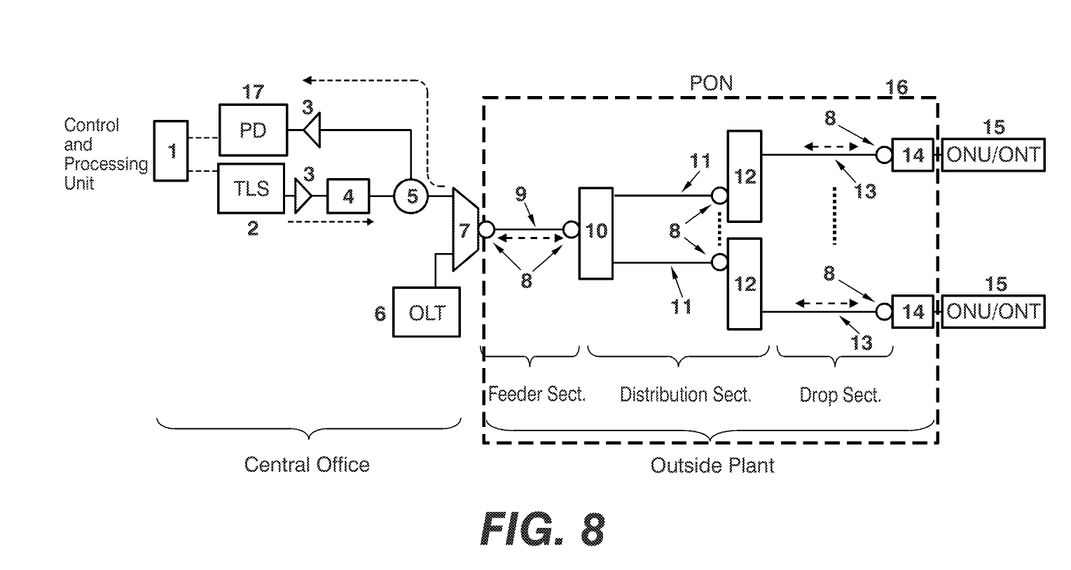

Two main options for FBG of TFF component installations are considered, for two respective embodiments:
Complete filter installation (see FIG. 4), in which all the reflective filters 8 are installed both at input and output of all the fibre cables. In this case, the number of required filters equals 2·[1+m·(n+1)].
Reduced filter installation (see FIG. 8), in which only the two filters 8 of the feeder fibre and the filters at the output of the fibre cables are installed. In this case the number of required filters equals 2+m·(n+1).

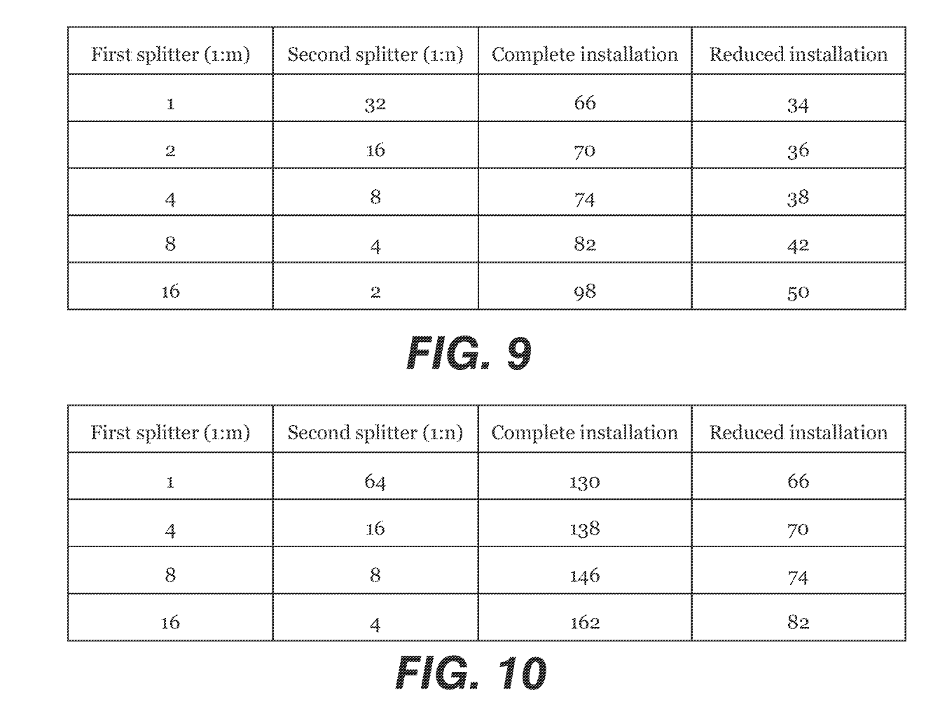

The number of filters 8 required for both options for different splitting values of the first-level and second level splitters and for a total splitting ratio of 1:32 and 1:64 are shown in FIG. 9 and FIG. 10, respectively.

The optical signal from the TLS is power split to all the drop fibres of the network, but it is only reflected by the FBG or TFF with the central wavelength corresponding to the current value of the TLS emitted wavelength at a time, thus providing information of the optical power reaching to the specific location of the FBG or TFF.

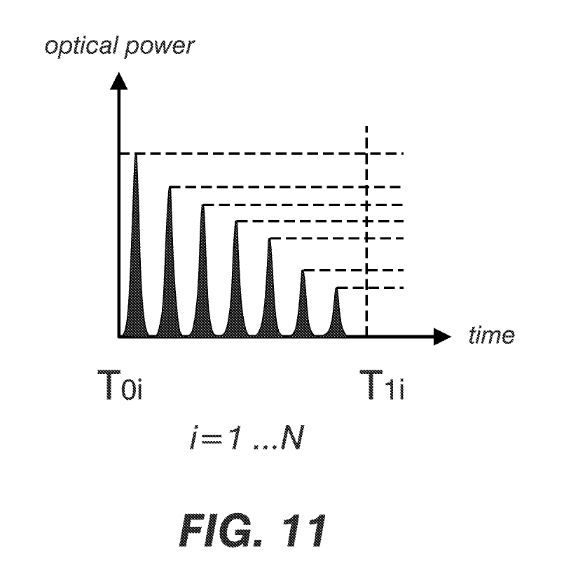

The reflected signals are amplified through an optical amplifier 3 and collected in the Central Office, then being delivered to a broadband photo-detector (PD) 17 through the circulator 5. A schematic example of the reflections from PON number ‘i’ is shown in FIG. 11.

The processing and analysis of the electrical signals permit to obtain the information of the optical power attenuation taking place at each individual component and fibre of the PON network, by obtaining the ratio between the peaks received at the photo-detector 17 in the Central Office (see FIG. 11).

It is required to know the location of each reflector and its central wavelength in order to know the point of the network where the reflections come from, each reflection corresponding to a unique point in the outside plant and a unique wavelength within the optical monitoring band or bands. By selecting a low enough minimum tuning time (T1i-T0i) for the TLS to change the operating wavelength between λ0 and λ1, the identification of each reflection can be performed in the time-domain because lower wavelength reflections are received prior to the reflections at higher wavelengths and each pair wavelength-location can be obtained from the order of the reflection after starting the TLS signal at time T0i with wavelength λ0.

### Advantages of the Invention:

This invention applies to FTTx topologies for PON systems, and enables the physical supervision of the network independently of active data equipment, reducing the operational expenditures (OPEX) of the network operator.

The functionality of the proposed monitoring system and method allows telecom operators to detect and identify the splitter or the fibre cable where a physical layer problem takes place in the outside plant of one or several PON networks:
Avoiding the ambiguities of previously reported techniques based on OTDR and FBGs, which in some cases are not capable of discerning the fibre branch at which a physical layer problem has occurred or whether the problem is inside the ONT/ONU.
Reducing the cost of tunable receptors in the Central Office such as Optical Spectrum Analyzers, due to the association between the location and order of reflection received from the outside plant.

The present invention is capable of reducing the operation and maintenance cost of PON networks, by entirely and rapidly characterizing the insertion losses of the splitters and fibre cables in a point to multipoint topology of a fibre outside plant from the Central Office in a cost effective way (OPEX reduction).

The proposal can be implemented using commercial equipment and optical components available in the mass market and the most innovative aspects of the invention are:
The unique association between time at which reflections are received from the outside plant and the location of the reflection, without the need for a tunable receptor.
The calculation of the components and fibre losses using the power ratio between reflections corresponding to the output and the input of an optical splitter or fibre cable.

The equipment and devices of the proposed system can be shared by several PON networks using an optical switch in the Central Office, synchronized with the Control and Processing Unit.

A person skilled in the art could introduce changes and modifications in the embodiments described without departing from the scope of the invention as it is defined in the attached claims.

### ACRONYMS

10G-EPON 10 Gigabit EPON
10G-GPON 10 Gigabit GPON
CO Central Office
CPE Customer Premises Equipment
EPON Ethernet PON
FBG Fibre Bragg Grating
FTTH Fibre to the Home
FTTx Fibre to the Building/Home/Node/Curb
GPON Gigabit PON
ITU-T International Telecommunication Union-Telecommunication
NGPON Next Generation PON
OLT Optical Line Termination
ONT/ONU Optical Network Terminal/Optical Network Unit
OPEX Operational Expenditure
OSA Optical Spectrum Analyzer
OTDR Optical Time Domain Reflectometry
PD Photo-Detector
PON Passive Optical Network
P2MP Point to Multi-Point
P2P Point to Point
PS Power Splitter
SMF Single-Mode Fibre
TFF Thin Film Filter
TLS Tunable Laser Source
WDM Wavelength Division Multiplexing

### REFERENCES

1. Telecommunication Standardization Sector of ITU. ITU-T G.984. Gigabit-capable Passive Optical Networks (GPON). 2008.
2. Institute of Electrical and Electronics Engineers (IEEE). IEEE 802.3ah. Ethernet in the First Mile (EPON). 2004.
3. Telecommunication Standardization Sector of ITU. ITU-T G.987. 10-Gigabit-capable passive optical networks (XG-PON). 2010.
4. Institute of Electrical and Electronics Engineers. IEEE Std 802.3av. Physical layer specifications and management parameters for 10 Gb/s passive optical networks. 2009.
5. Telecommunication Standardization Sector of ITU. Recommendation ITU-T G.650.3. Test methods for installed single-mode optical fibre cable links. 2008.
6. Recommendation ITU-T L66. Optical fibre cable maintenance criteria for in-service fibre testing in access networks. 2007.
7. Monitoring technique for a hybrid PS/WDM-PON by using a tunable OTDR and FBGs. Arii, Masahito, Izumita, Hisashi y Yamauchi, Osamu. s.l.: Measurement Science and Technology, 2006, Vol. 17.
8. RECENT DEVELOPMENTS IN FIBER OPTICS MAINTENANCE SYSTEM FOR ACCESS NETWORKS. Arii, Masahito, Izumita, Hisashi y Yamauchi, Osamu. Vietnam: s.n., 2005. International Symposium on Electrical-Electronics Engineering (ISEE2005).
9. Design of Identification Fibers With Individually Assigned Brillouin Frequency Shifts for Monitoring Passive Optical Networks. Iida, Daisuke, y otros. 5, s.l.: Journal of Lightwave Technology, 2007, Vol. 25.
10. Yang, Sulin. Method and apparatus for detecting passive optical network failures, and passive optical network system thereof. US 2009/0269053 A1.
11. Holland, William R. Test and measurement system for detecting and monitoring faults and losses in passive optical networks (PONs). U.S. Pat. No. 6,396,575 B1.

1. A method for physical layer monitoring in Passive Optical Networks, comprising:
a) providing optical reflectors at different points of a Passive Optical Network, or PON;
b) injecting a monitoring light signal at an input of said PON to circulate there through;
c) reflecting back, said optical reflectors, at least part of said monitoring light signal, in the form of respective reflected light signals;
d) receiving said respective reflected light signals from said optical reflectors; and
e) analysing said received reflected light signals to perform a physical layer monitoring of the PON;
wherein:
said step a) comprises providing said optical reflectors within the outside plant of the PON for reflecting, each, a light signal with a specific and individualized wavelength;
said step b) comprises varying the wavelength of said monitoring light signal through a specific range covering the individualized wavelengths that said optical reflectors reflect;
said step c) comprises having at least two of said reflected light signals for each fibre of the drop section in said PON; and
said step e) comprises determining at least the location of each of said optical reflectors as a function of the arrival order, at said PON input, of its respective reflected signal, using previous knowledge about which specific wavelength each reflector reflects.

2. A method as per claim 1, wherein said injection of said varying wavelength monitoring light signal of step b) is performed by means of at least one sweep.

3. A method as per claim 1, wherein said step d) comprises receiving said reflected light signals at said PON input.

4. A method as per claim 1, wherein said step e) comprises calculating the optical losses at each of said PON points by calculating power ratios between the sequentially received reflected light signals.

5. A method as per claim 1, wherein said monitoring light signal is a laser light signal.

6. A method as per claim 5, comprising using a tunable laser source to emit said laser light signal in the form of a continuous-wave signal.

7. A method as per claim 1, comprising associating each of said PON different points to the optical reflector provided thereat, and considering said optical reflector location determined at step e) as the location of the respective PON point associated thereto.

8. A method as per claim 7, wherein said PON points are an input and/or output of an optical fibre of at least one of: a feeder section, a distribution section and a drop section.

9. A method as per claim 1, wherein said step e) comprises calculating the optical attenuation of an optical fibre section or of a splitter by obtaining the ratio between the reflected light signals received from the optical reflectors provided at, respectively, its input and output.

10. A method as per claim 1, comprising selecting said PON from a plurality of PONs before performing said steps b) to e).

11. A method as per claim 10, comprising sequentially selecting each of said plurality of PONs and performing said injection of said varying wavelength monitoring light signal of step b) to each PON by means of sequentially applying said at least one sweep with a periodic signal.

12. A system for physical layer monitoring in Passive Optical Networks, comprising:
a light source arranged for injecting a monitoring light signal at an input of a PON to circulate there through;
a plurality of optical reflectors provided at different points of said PON for receiving said monitoring light signal and reflecting back at least part thereof, in the form of respective reflected light signals;
light detecting means arranged for receiving said respective reflected light signals from said optical reflectors; and
analysis means connected to said light detecting means for analysing said received reflected light signals to perform a physical layer monitoring of the PON;
wherein:
said optical reflectors reflect, each, a light signal with a specific and individualized wavelength;
said light source varies the wavelength of said monitoring light signal through a specific range covering the individualized wavelengths that said optical reflectors (8) reflect;
said light detecting means detect light signals of at least said wavelengths specific range; and
said analysis means have access to previous knowledge about which specific wavelength each reflector reflects, and determine, using said previous knowledge, at least the location of each of said optical reflectors as a function of the arrival order, at said light detecting means, of its respective reflected signal.

13. A system as per claim 12, wherein said light source is a tunable laser source which emits said monitoring light signal in the form of a continuous-wave laser light signal.

14. A system as per claim 12, comprising control means for controlling said light source.

15. A system as per claim 12, wherein said light detecting means comprise at least one broad-band photodetector generating and sending to said analysing means electrical signals corresponding to the received reflected light signals.

16. A system as per claim 15, comprising a control and processing unit including said analysis means and said control means.

17. A system as per claim 12, wherein said light detecting means are arranged for receiving said respective reflected light signals via said PON input.

18. A system as per claim 17, comprising an optical circulator connected at said PON input to direct said monitoring light signal from the light source to the PON, and to direct the reflected light signals from the PON towards said light detecting means.

19. A system as per claim 12, wherein said PON points where respective optical reflectors are provided are an input and/or output of an optical fibre of at least one of: a feeder section, a distribution section and a drop section.

20. A system as per claim 12, wherein said optical reflectors are of at least one of the next types: Fibre Bragg Gratings, or FBGs, and Thin Film Filters, or TFFs, with different central wavelengths.

21. A system as per claim 12, comprising filters for avoiding interference between the monitoring light signal and PON signals existing in other optical bandwidth.

22. A system as per claim 12, wherein said plurality of optical reflectors are provided at different points of a plurality of PONs (PON₁ to PON_{N}), and wherein the system comprises an optical switch arranged for selectively directing said monitoring light signal and said reflected light signals, respectively, towards and from at least one of said plurality of PONs (PON₁ to PON_{N}).

23. A system as per claim 22, wherein said optical switch sequentially directs the monitoring light signal and the reflected light signals, respectively, towards and from each of said plurality of PONs (PON₁ to PON_{N}).
